(19) United States
(12) Patent Application Publication
(10) Pub. No.: US 2026/0050070 A1
(43) Pub. Date: Feb. 19, 2026

(54) SYSTEMS AND METHODS FOR ENTANGLEMENT ASSISTED MULTISTATIC QUANTUM RADAR

(71) Applicant: Arizona Board of Regents on Behalf of the University of Arizona, Tucson, AZ (US)

(72) Inventor: Ivan B. Djordjevic, Tucson, AZ (US)

(21) Appl. No.: 19/102,147

(22) PCT Filed: Aug. 10, 2023
(86) PCT No.: PCT/US2023/072044

§ 371 Date: Feb. 7, 2025

Related U.S. Application Data
(60) Provisional application No. 63/396,901, filed on Aug. 10, 2022.

(51) Int. Cl. G01S 7/4911; G01S 7/481; G01S 7/4915; G02F 1/35; G02F 1/355; G02F 1/39

(52) U.S. Cl. CPC G01S 7/4911; G01S 7/4815; G01S 7/4915; G02F 1/3534; G02F 1/3551; G02F 1/3558; G02F 1/392; G02F 2202/20; G02F 2203/11

(57) ABSTRACT

An entanglement-assisted multistatic quantum radar detection technique employs the integrated entangled source shared among multiple transmitters and performing transmit side optical phase conjugation. EA receivers are based on classical homodyne detection schemes. The EA multistatic radar detection technique is evaluated against bistatic radar EA detection scheme and various coherent states-based quantum detection schemes (the optimum quantum detector. Helstrom threshold detector, and random phase optimum quantum detector). The EA multistatic target detection probability is significantly better than that of corresponding bistatic radar EA detection techniques. coherent states-based quantum detection techniques. and the classical radar detection schemes. When both scattered signal photon channels and idler channels are noisy and lossy, the scheme significantly outperforms the EA bistatic radar scheme.

### CROSS REFERENCE TO RELATED APPLICATIONS

The present document is a PCT patent application that claims benefit to U.S. Provisional Application Ser. No. 63/396,901, filed on Aug. 10, 2022, which is herein incorporated by reference in its entirety.

### FIELD

The present disclosure generally relates to quantum information processing (QIP), and in particular, relates to a system and associated method for entanglement assisted quantum radar.

### BACKGROUND

Quantum information processing (QIP) opens new avenues for numerous applications, including high-performance computing, high-precision sensing, and secure communications. Among various QIP attributes, entanglement is a unique QIP feature and may be used to implement quantum computers capable of solving problems that are numerically intractable for classical computers. Entanglement-based approaches may also lead to quantum-enhanced sensors with measurement sensitivities that exceed classical limits.

For example, entanglement represents a unique quantum information processing (QIP) attribute that can enable: (1) outperforming classical sensor sensitivity; (2) unconditional security for future communication networks; and (3) exceeding classical channel capacities. Additionally, pre-shared entanglement can enable distributed quantum sensing and/or secure distributed quantum computing.

One motivation behind quantum target detection studies is to outperform the quantum limit of classical sensors. For example, quantum radars outperform classical radars in terms of detection probability in low signal-to-noise ratio (SNR) regimes and in range estimation. Quantum radars have several advantages compared to corresponding classical radar counterparts: improved receiver sensitivity, better detection probability of targets (e.g., particularly in a low SNR regime), improved synthetic-aperture radar imaging quality, improved detection through clouds and fog (e.g., particularly when microwave photons are used), better resilience to jamming, higher cross-section, among others. Moreover, quantum radar signals are more difficult to detect compared to classical radar signals. Recently, two popular quantum radar designs have emerged: (i) the quantum radar employing Lloyd's quantum illumination sensing concept and (ii) the interferometric quantum radar.

It is with these observations in mind, among others, that various aspects of the present disclosure were conceived and developed.

### BRIEF DESCRIPTION OF THE DRAWINGS

FIG. 1 is a simplified diagram showing an example entanglement assisted (EA) joint multistatic quantum radar system and technique;

FIG. 2 is a simplified diagram showing an example joint multistatic LiNbO₃-based integrated EA transmitter with transmit side OPC;

FIG. 3 is a simplified diagram showing an EA detector based on a balanced coherent detector that measures either in-phase or quadrature component of the forward scattered beam;

FIG. 4 is a graphical representation showing detection probability vs. SNR [dB] for different radar detection schemes for an average number of thermal photons set to N_{b}=10; and

FIG. 5 is a graphical representation showing detection probability vs. SNR [dB] for EA joint detection schemes for a fixed idler channel transmissivity.

Corresponding reference characters indicate corresponding elements among the view of the drawings. The headings used in the figures do not limit the scope of the claims.

### DETAILED DESCRIPTION

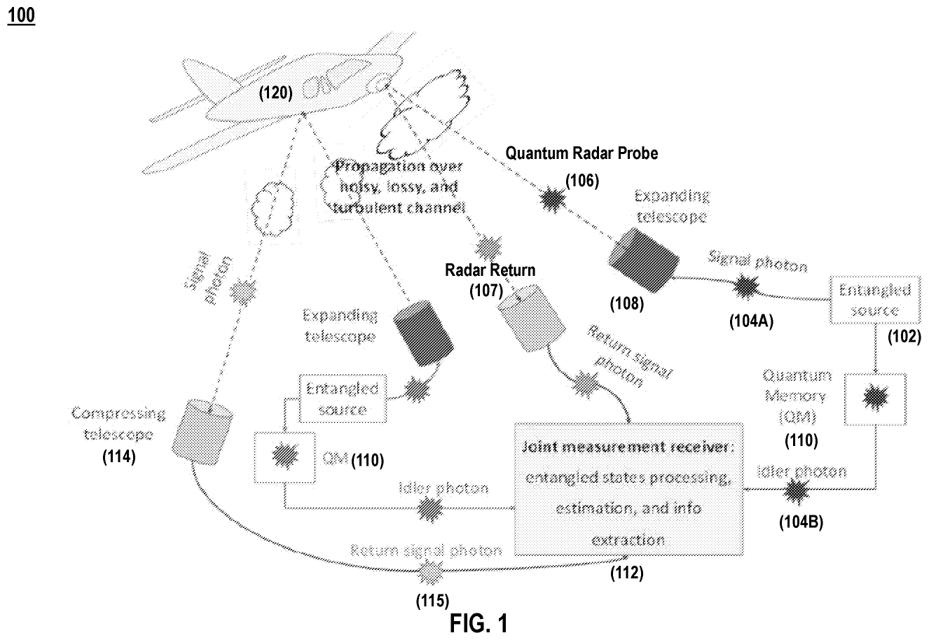

Aspects of the present disclosure provide systems and methods for an entanglement assisted (EA) joint multistatic quantum radar detection scheme with a corresponding operational principle (hereinafter, system 100) being depicted in FIG. 1. FIG. 1 shows a 2−2 multiple-input multiple-output (MIMO) example of the system 100 employing a plurality of entangled transmitters performing transmitter-side optical phase conjugation (OPC), a plurality of coherent detection-based receivers serving as EA detectors, and a joint detector.

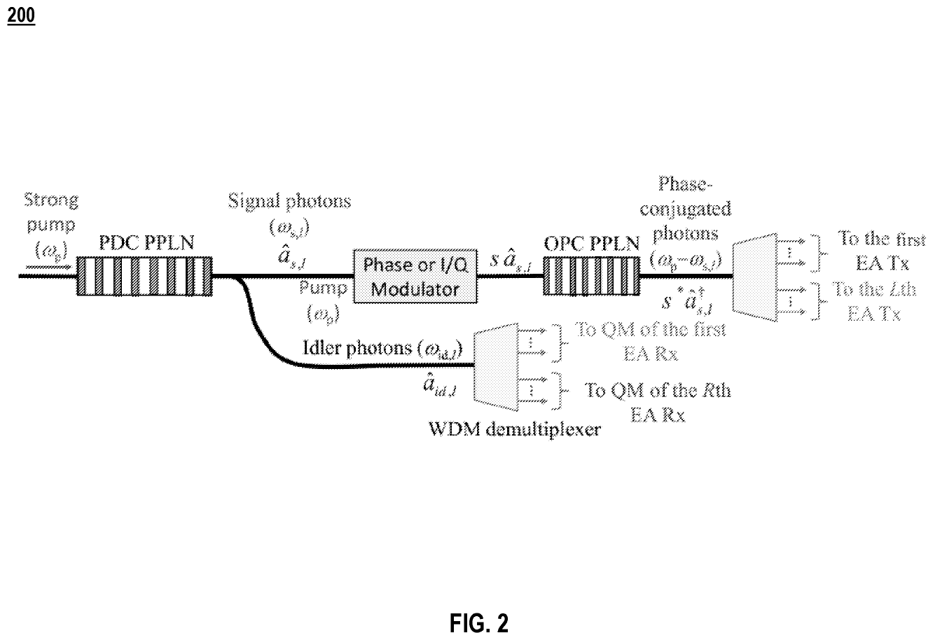

Each entangled transmitter can be considered a wideband entangled source; each respective entangled transmitter of the plurality of entangled transmitters generates at least one entangled pair of photons 104, each pair of entangled states including a signal photon 104A and an idler photon 104B. The idler photons are kept in quantum memories (110) of the receivers (112). The signal photons are transmitted over a noisy, lossy, and atmospheric turbulent channel towards a target 120 (e.g., the target in the top left of FIG. 1), and the forward-scattered photons are detected by the receivers (or a joint measurement receiver). The system 100 exploits inherent spatial diversity to improve tolerance to turbulence effects and increase the probability of target detection. The transmitters, example shown as EA transmitter 200 in FIG. 2, (e.g., the entangled sources) employ a continuous-wave spontaneous parametric down conversion (SPDC) process, generating the signal-idler photon pairs.

To simplify design and reduce costs while improving target detection probability, the system 100 applies optical phase conjugation (OPC) on the transmitter side rather than on the receiver side so that conventional balanced coherent detectors can be used as the EA detectors. The entanglement-assisted (EA) detectors are based on classical coherent detection with an idler mode having the same role as a local oscillator (LO) laser signal. Further, the system 100 uses a single broadband entangled source combined with a Wavelength Division Multiplexing (WDM) demultiplexer as a common source for all transmitters, which is illustrated in FIG. 2.

The EA joint multistatic target detection scheme implemented by the system 100 significantly outperforms coherent state-based quantum detection, EA monostatic, bistatic, and classical radar counterparts. The EA joint multistatic target detection scheme is further evaluated through numerical results provided herein. Finally, the present discussion assumes that the distribution of entanglement over the idler channels is not perfect.

With continued reference to FIG. 1, the EA joint multistatic target detection scheme implemented by the system 100 can employ telescopes to increase the probability of target detection. In particular, the system 100 can include an expanding telescope 108 between an entangled source (102) of the plurality of entangled sources and the target 120 when transmitting the signal photon 104A and can further include a compressing telescope 114 between the target and the joint receiver when receiving the return signal photon (115). In some examples, the system 100 can include an expanding telescope 108 between each entangled source 102 (e.g., of the plurality of entangled sources). In some examples, the system 100 can include multiple compressing telescopes 114 between the target 120 and the joint receiver 112. For instance, a quantity of compressing telescopes between the target 120 and the joint receiver 112 can be equal to or higher than a quantity of expanding telescopes and/or can be equal to a quantity of signal modes. As shown, in the context of EA joint multistatic target detection, expanding telescopes and compressing telescopes can be implemented for each individual entangled source of the plurality of entangled sources. In some embodiments, multiple transmitter apertures within the same expanding telescope are used to illuminate different portions of the target and ensure statistical independence of different reflections or scattered modes such that the spatial diversity can be utilized.

### Entanglement Assisted Radar Detection

This section describes an example entanglement assisted (EA) monostatic radar target detection scheme, employing the Gaussian states generated through the continuous-wave SPDC process. It is noted that the present system is focused on multistatic radar target detection (e.g., employing a multiple input multiple output scheme), however an overview of monostatic radar target detection (e.g., using a single input single output scheme) is provided here for review. For monostatic radar target detection, an SPDC-based entangled source represents a broadband source having D=TₘW i.i.d. (independent and identically distributed) signal-idler photon pairs, where Tₘ is the measurement interval and W is the phase-matching SPDC bandwidth. Each respective signal-idler photon pair is a two-mode squeezed vacuum (TMSV) state whose representation in Fock basis is given by:

$${\vert Ψ 〉}_{s , i} = \frac{1}{\sqrt{{N}_{s} + 1}} {\sum }_{n = 0}^{∞} {( \frac{{N}_{s}}{{N}_{s} + 1} )}^{n / 2} \vert n {〉}_{s} \vert n {〉}_{i} , \qquad ( i )$$

Here, Nₛ= [symbol] \hat{α}^{†}ₛ\hat{α}ₛ [symbol] = [symbol] \hat{α}^{†}ᵢ\hat{α}ᵢ [symbol] is the mean photon number per mode, with corresponding signal and idler creation operators being denoted by

$${\hat{a}}_{s}^{†} and {\hat{a}}_{i}^{†} ,$$

respectively. The signal-idler entanglement is characterized by the phase-sensitive cross-correlation (PSCC) coefficient, defined as [symbol] \hat{α}ₛ\hat{α}ᵢ≤=\sqrt{Nₛ(Nₛ+1)}, which can be considered as the quantum limit.

The TMSV state represents a pure maximally entangled zero-mean Gaussian state with the following Wigner covariance matrix:

$${\sum }_{TMSV} = [ \begin{matrix}( 2 {N}_{s} + 1 ) 1 & 2 \sqrt{{N}_{s} ( {N}_{s} + 1 )} Z \\ 2 \sqrt{{N}_{s} ( {N}_{s} + 1 )} Z & ( 2 {N}_{s} + 1 ) 1\end{matrix} ] , \qquad ( ii )$$

Here, Z=diag(1,−1) denotes the Pauli Z-matrix and 1 denotes the identity matrix.

In the low-brightness regime Nₛ<<1, the PSCC is [symbol] \hat{α}ₛ\hat{α}ᵢ [symbol] ≈\sqrt{Nₛ} that is much larger than the corresponding classical limit Nₛ. The entangled source is used on the transmitter side to generate a quantum correlated signal photon (e.g., quantum radar probe, or simply probe 106) and an idler photon, which serves as a local reference. The signal photon is transmitted with the help of an expanding telescope (e.g., with a large/wide field of view) over a noisy, lossy, and atmospheric turbulent channel towards the target. The reflected photon (e.g., the radar return 107) is detected by the radar's receiver, and quantum correlation between the radar return and a retained reference (e.g., the idler photon) is exploited on the receive side to improve the receiver sensitivity.

The interaction between the probe 106 (e.g., signal) photon and the target can be described by a beam splitter of transmissivity T^{(r)}. Therefore, the radar transmitter-target-radar receiver (e.g., directly reflected mode) channel (e.g., direct return channel) can be modeled as a lossy thermal Bosonic channel:

$${\hat{a}}_{Rx}^{( r )} ( φ ) = \sqrt{{T}^{( r )}} {e}^{- j {φ}^{( r )}} {\hat{a}}_{s} + \sqrt{1 - {T}^{( r )}} {\hat{a}}_{b}^{( i )} , \qquad ( iii )$$

Here.

$${\hat{a}}_{b}^{( r )}$$

is a background (thermal) state of the direct return channel with the mean photon number being

$$( 1 - {T}^{( r )} ) 〈 {\hat{a}}_{b}^{( r ) †} {\hat{a}}_{b}^{( r )} 〉 = {N}_{b} .$$

Signal-mode phase shift introduced by the target and channel is denoted as γ^{(r)}. The idler-mode channel is also modelled as the lossy and noisy Bosonic channel:

$${\hat{a}}_{Rx , idler} = \sqrt{{T}^{( i )}} {\hat{a}}_{i} + \sqrt{1 - {T}^{( i )}} {\hat{a}}_{b}^{( i )} , \qquad ( iv )$$

Here, T⁽ⁱ⁾ is transmissivity of the idler channel and

$${\hat{a}}_{b}^{( i )}$$

is the annihilation operator of the background (e.g., thermal) mode of the idler channel with the mean photon number being

$$( 1 - {T}^{( i )} ) 〈 {\hat{a}}_{b}^{( i ) †} {\hat{a}}_{b}^{( i )} 〉 = {N}_{b}^{( i )} .$$

The radar returned probe and retained reference (stored idler) can be described by the following covariance matrix:

$${\sum }_{t} = [ \begin{matrix}( 2 {N}_{s} + 1 ) 1 & 2 \sqrt{{T}^{( r )} {T}^{( i )} {N}_{s} ( {N}_{s} + 1 )} Z {δ}_{1 t} \\ 2 \sqrt{{T}^{( r )} {T}^{( i )} {N}_{s} ( {N}_{s} + 1 )} Z {δ}_{1 t} & ( 2 {N}_{s}^{( r )} + 1 ) 1\end{matrix} ] . \qquad ( v )$$

Here,

$${N}_{s}^{( r )} = ( {T}^{( i )} {N}_{s} + {N}_{b}^{( i )} ) {T}^{( r )} + {N}_{b} .$$

The target indicator is denoted as t. In the absence of the target, t=0 (and in this case the return signal does not contain a probe, just the background noise) and the covariance matrix is diagonal. On the other hand, in the presence of the target t=1 and antidiagonal terms (e.g., representing the quantum correlation between the signal and idler) are non-zero.

The EA monostatic radar receiver may use an optical parametric amplifier (OPA), (e.g., as an OPA-based EA target detection receiver), with a low gain G−1=ε<<1, to obtain:

$${\hat{a}}^{( r )} ( {φ}^{( r )} ) = \sqrt{G} {\hat{a}}_{Rx , idler} + \sqrt{G - 1} {\hat{a}}_{Rx}^{( r ) †} ( {φ}^{( r )} ) \qquad ( vi )$$

for each signal-idler pair of a given mode. The direct detection of the OPA has the following mean photon number: N̅(γ^{(r)})=[ [symbol] \hat{α}^{(r)}γ^{(r)}]^{†}\hat{α}^{(r)}(γ^{(r)}) [symbol] .

In some aspects, it can be seen that OPA-based EA receivers, for an ideal distribution of the idler (T⁽ⁱ⁾=1), provide ≤3 dB improvement over corresponding classical receivers. In the presence of experimental imperfections, the improvement was reduced down to 1 dB. Given that the OPC receiver outperforms the OPA receiver for monostatic detection, the system 100 employs the EA joint multistatic target detection scheme that employs the OPC for each transmitter of a plurality of transmitters on the transmitter side and classical coherent detection at the joint receiver positioned at the receiving end.

### Entanglement Assisted Joint Multistatic Radar Detection Scheme

This section provides details about the system 100 that employs the entanglement assisted joint multistatic radar detection concept described herein (e.g., the system 100 shown in FIG. 1), which in some aspects can be based on the recently proposed EA communication system (see, for example, commonly owned U.S. Provisional Patent Application No. US 63/352,540, the contents of which are herein incorporated by reference in their entirety). In some embodiments, multiple expanding telescopes per transmitter are used so that different portions of the target can be illuminated. Alternatively, or additionally, multiple apertures per expanding telescope can be used. The entangled transmitters are properly separated on such a way that the corresponding transmitters-target-forward scattered channels are statistically independent so that the full diversity can be achieved.

The system 100 uses a single broadband entangled source combined with a Wavelength Division Multiplexing (WDM) demultiplexer as a common source for the plurality of transmitters, which is illustrated in FIG. 2. A first periodically poled LiNbO3 (PPLN) waveguide serves as the SPDC source, which generates a large number of signal-photon pairs (only the [symbol] ^{th} signal-photon pair is illustrated in FIG. 2, but it is noted that a plurality of signal-photon pairs may be processed by the system 100 at a time). Signal and idler photons are separated by a properly designed Y-junction. Idler photons are further separated by the WDM demultiplexer of FIG. 2 with corresponding outputs being directed towards the quantum memories (QMs) of corresponding EA receivers. Given that QMs are not widely available the properly designed optical delay lines can be used instead. On the other hand, all signal photons are simultaneously modulated by a training sequence known to all EA receivers within the system 100. This sequence is used to estimate a phase shift introduced by the target and the channel. A second PPLN waveguide is used to perform OPC by employing a difference frequency generation (DFG) process, in which the [symbol] ^{th} signal photon at angular frequency [symbol] interacts with the pump photon ωₚ to yield the phase-conjugated (PC) photon at radial frequency [symbol] . The WDM demultiplexer is then used to separate the signal photons corresponding to each respective (multistatic) transmitter of the plurality of transmitters of the system 100, as shown in FIG. 1.

To provide an illustrative example corresponding to FIG. 1, with the strong pump at λₚ=780 nm, through the SPDC (e.g., with the help of the first PPLN waveguide) the following signal-idler pairs are generated:
(1) the idler photon 1 at λ_{i,1}=1536 nm and the signal photon 1 at λ_{S,1}=1584.8 nm; and
(2) the idler photon 2 at λ_{i,2}=1540 nm and the signal photon 2 at λ_{S,2}=1580.5 nm.

After the OPC, through DFG (with the help of the second PPLN waveguide) the signal photon 1 and the signal photon 2 each interact with the pump photon to yield the PC signal photon at λ_{S,1,PC}=1536 nm for the signal photon 1 and at λ_{S,2,PC}=1540 nm for the signal photon 2, representing the same wavelength as that of the corresponding idler photon 1 and the idler photon 2.

The signal constellation point imposed by phase or I/Q modulator is denoted by s, which for M-ary phase shift keying (PSK) s is simply exp(jθₘ), where θₘ=m2π/M; m=0,1. . . , M−1.

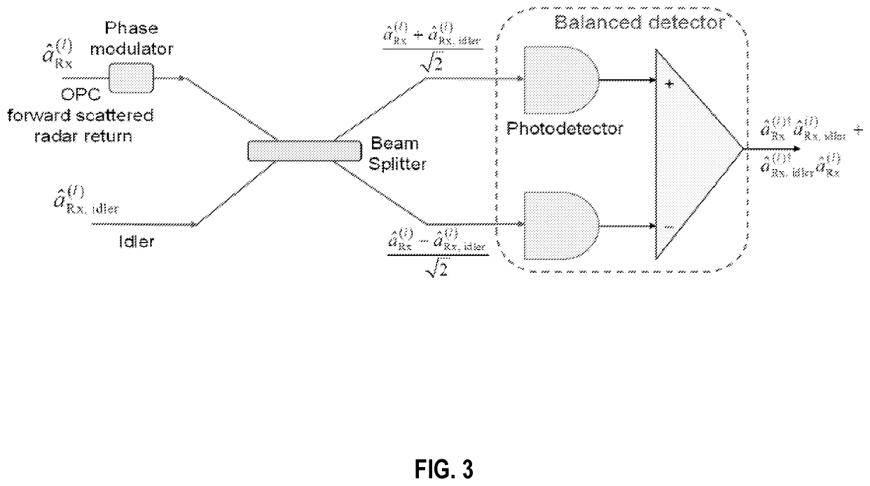

Given that the OPC is performed on the transmitter side, it is not necessary to use OPC-based EA receivers; rather, commercially-available classical balanced coherent detectors can be used as the EA receivers, such as one shown in FIG. 3, thus reducing the overall system cost and complexity. FIG. 3 shows an EA receiver corresponding to the [symbol] forward scattered component based on homodyne balanced detection. The receive side phase modulator is used to detect either in- phase or quadrature component of the corresponding PC signal. Without loss of generality, the photodiode responsivity is set to 1 A/W. This is particularly true when number of receivers is much larger than the number of transmitters, so that the number of required OPC modules can be reduced. Even when the number of receivers is comparable to the number of transmitters it is still advantageous to place the OPC on transmitter side because the SPDC and OPC modules can be integrated on the same chip, as discussed above with respect to FIG. 2.

The interaction between the forward scattered signal probe photon and the target can be described by a beam splitter of transmissivity T [symbol] (with one input being the probe and the other input being the thermal mode. So, a channel from the m^{th} radar transmitter to the target and to the [symbol] radar forward-scattered mode channel are modeled as a lossy and noisy Bosonic channel, which for transmit-side OPC is described by:

$${\hat{a}}_{RX , m}^{( l )} ( {φ}_{m}^{( l )} ) = \sqrt{{T}_{m}^{( l )}} {e}^{- j {φ}_{m}^{( l )}} {\hat{a}}_{s , m}^{( l ) †} \sqrt{1 - {T}_{m}^{( l )}} {\hat{a}}_{b}^{( l )} , \qquad ( 1 )$$

where

$${\hat{a}}_{b}^{( l )}$$

is a thermal (background) state of the [symbol] ^{th} scattered beam whose mean photon number is

$$( 1 - {T}_{m}^{( l )} ) 〈 {\hat{a}}_{b}^{( l ) †} {\hat{a}}_{b}^{( l )} 〉 = {N}_{b}^{( l )} .$$

The phase

$${φ}_{m}^{( l )}$$

has three components:

$${φ}_{m}^{( l )} = {θ}_{mod} + {ϑ}_{m}^{( l )} + {ϕ}_{m}^{( l )} \qquad ( 2 )$$

where θ_{mod} is the Q-ary PSK modulation phase and

$${ϑ}_{m}^{( l )}$$

is the deterministic phase-shift introduced by the [symbol] ^{th} forward-scattered mode channel (originating from the m^{th} transmitter). Under assumption that the distance between the receiver and the target in the forward-scattered mode channel is

$${R}_{m}^{( l )} ,$$

the target-introduced phase-shift will be

$${ϑ}_{m}^{( l )} = k ( {r}_{m} + {R}_{m}^{( l )} ) \qquad ( 3 )$$

where rₘ is the distance between transmitter m and target, while k denotes the wave number. Finally,

$${ϕ}_{m}^{( l )}$$

is the the [symbol] ^{th} scattered mode-induced random phase shift. The phase modulator on transmitter side, based on M-ary PSK, is employed to impose the sequence common for all transmitters, which is later used on receivers' sides to estimate the random phase shift. The common sequence can also be used to determine the delay between the signal and idler photons, by applying the crosscorrelation method. Instead of sending a single pulse in each signaling interval, a high-speed M-ary PSK-modulated packet can be sent instead. Given that receivers know the transmitted sequence they can apply the crosscorrelation method, once the presence of the target is detected by the EA detector, to estimate the delay between signal and idler photons. The potential jammer will not know what the common sequence is and will need to apply the brute force approach.

The channel with idler-mode is modelled as less noisy and less lossy Bosonic channel compared to the scattered modes, so:

$${\hat{a}}_{Rx , idler}^{( m )} = \sqrt{{T}_{m}^{( i )}} {\hat{a}}_{m}^{( i )} + \sqrt{1 - {T}_{m}^{( i )}} {\hat{a}}_{b}^{( i )} , \qquad ( 4 )$$

where

$${T}_{m}^{( i )}$$

denoted the idler-channel transmissivity corresponding to the m-th transmitter and

$${\hat{a}}_{b}^{( i )}$$

is the thermal (background) mode annihilation operator of the of the idler channel whose mean photon number is

$$( 1 - {T}_{m}^{( i )} ) 〈 {\hat{a}}_{b}^{( i ) †} {\hat{a}}_{b}^{( i )} 〉 = {N}_{b}^{( i )} .$$

The relationship between the radar returned probe over [symbol] -th scattered mode channel and retained reference (stored idler) corresponding to the m-th transmitter can be described by the Wigner covariance matrix as follows:

$${\sum }_{t}^{( m , l )} = [ \begin{matrix}( 2 {N}_{s} + 1 ) 1 & 2 \sqrt{{T}_{m}^{( l )} {T}_{m}^{( i )} {N}_{s} ( {N}_{s} + 1 )} Z {δ}_{1 t} \\ 2 \sqrt{{T}_{m}^{( l )} {T}_{m}^{( i )} {N}_{s} ( {N}_{s} + 1 )} Z {δ}_{1 t} & ( 2 {N}_{s}^{( m , l )} + 1 ) 1\end{matrix} ] , \qquad ( 5 )$$

where

$${N}_{s}^{( m , l )} = ( {T}_{m}^{( i )} {N}_{s} + {N}_{b}^{( i )} ) {T}_{m}^{( l )} + {N}_{b}^{( l )}$$

and subscript t is used as a target indicator. When the target is present, for t=1, the antidiagonal terms, related to the phase-sensitive quantum correlation between the signal and idler, are non-zero. On the other hand, when the target is absent, for t=0, the return signal contains only thermal (background) noise, and the covariance matrix is a diagonal one.

The photocurrent operator of the balanced detector (BD) (under assumption that the photodiode responsivity is 1 A/W) for EA detector corresponding to the [symbol] -th scattered mode channel and m-th transmitter, depicted in FIG. 2, is given by:

$${\hat{ι}}_{BD , m}^{( l )} = {( {\hat{a}}_{Rx . m}^{( l )} )}^{†} {\hat{a}}_{Rx , idler}^{( m )} + {( {\hat{a}}_{Rx , idler}^{( m )} )}^{†} {\hat{a}}_{Rx , m}^{( l )} , \qquad ( 6 )$$

For the receive side phase modulator shift being set to zero (Δφ=0 rad), when the target is present (t=1), the photocurrent operator expectation of the BD corresponding to the [symbol] -th scattered-mode channel and the m-th transmitter is obtained as:

$$〈 {\hat{ι}}_{BD , m}^{( l )} ( Δ φ = 0 ) 〉 = 2 \sqrt{{T}_{m}^{( i )} {T}_{m}^{( l )} {N}_{s} ( {N}_{s} + 1 )} cos {φ}_{m}^{( l )} , \qquad ( 7 )$$

For the receive side phase modulator shift is set to Δφ=−π/2 rad, when the target is present (t=1), the photocurrent operator expectation of the BD corresponding to the [symbol] -th scattered-mode channel and the m-th transmitter is obtained as:

$$〈 {\hat{ι}}_{BD , m}^{( l )} ( Δ φ = - π / 2 ) 〉 = 2 \sqrt{{T}_{m}^{( i )} {T}_{m}^{( l )} {N}_{s} ( {N}_{s} + 1 )} sin {φ}_{m}^{( l )} . \qquad ( 8 )$$

In order to determine the target range, the exact phase-shift is needed; and to find the exact phase-shift both quadrature components are required. Namely, from Eqs. (7) and (8) the overall phase is determined as follows:

$${φ}_{m}^{( l )} = {tan}^{- 1} [ \frac{〈 {\hat{ι}}_{BD , m}^{( l )} ( Δ φ = - π / 2 ) 〉}{〈 {\hat{ι}}_{BD , m}^{( l )} ( Δ φ = 0 ) 〉} ] . \qquad ( 9 )$$

Given that θ_{mod} is known by receivers, the deterministic phase

$${ϑ}_{m}^{( l )} = k ( {r}_{m} + {R}_{m}^{( l )} )$$

is determined based on Eq. (2). By tapping the portion of the huge wavelength band of the SPDC process, a classical heterodyne balanced detector can be used, followed by a correlator to determine the delay between the signal and idler photons, and this information can be used to adjust the variable optical delay line storing the idler photons. This delay is also related to the target range.

When the modulator shift of the receive side phase modulator is set to Δφ=0 rad, the variance of the photocurrent operator of the BD, defined as

$$Var ( {\hat{ι}}_{BD , m}^{( l )} ) = 〈 {( {\hat{ι}}_{BD , m}^{( l )} )}^{2} 〉 - {〈 {\hat{ι}}_{BD , m}^{( l )} 〉}^{2} ,$$

corresponding to the m-th transmitter and [symbol] -th scattered mode will be:

$$Var ( {\hat{ι}}_{BD , m}^{( l )} ) = {N}_{m}^{( i )} {N}_{s , m}^{( l )} + ( {N}_{m}^{( i )} + 1 ) ( {N}_{s , m}^{( l )} + 1 ) + 2 {N}_{s} {T}_{m}^{( l )} {T}_{m}^{( i )} ( {N}_{s} + 1 ) [ cos ( 2 {φ}_{m}^{( l )} ) - 2 {cos}^{2} {φ}_{m}^{( l )} ] , \qquad ( 10 )$$

$$where {N}_{s , m}^{( l )} = ( {T}_{m}^{( i )} {N}_{s} + {N}_{b}^{( i )} ) {T}_{m}^{( l )} + {N}_{b}^{( l )} .$$

When the target is absent, the photocurrent operator expectation of the BD is zero, and since Nᵢ=Nₛ, the corresponding variance will be:

$$Var ( {\hat{ι}}_{BD , t = 0}^{( l )} ) = {N}_{i} {N}_{b}^{( l )} + ( {N}_{i} + 1 ) ( {N}_{b}^{( l )} + 1 ) = {N}_{s} {N}_{b}^{( l )} + ( {N}_{s} + 1 ) ( {N}_{b}^{( l )} + 1 ) , \qquad ( 11 )$$

Because in the problem of a target detection a priori probabilities are not known, it is necessary to employ the Neyman-Pearson criterion, in which the false alarm probability is set to the maximum tolerable value to maximize the detection probability of the target.

The proposed EA multistatic radar false alarm (FA) probability is given by:

$${Q}_{FA} = \frac{1}{2} erfc ( \frac{{t}_{sh}}{\sqrt{{N}_{s} {N}_{b} + ( {N}_{s} + 1 ) ( {N}_{b} + 1 )}} ) , \qquad ( 12 )$$

wherein tₛₕ denotes the threshold derived from the set FA probability. The complementary error function in (12) is defined by

$$erfc ( x ) = ( 2 / \sqrt{π} ) {\int }_{x}^{∞} exp ( - {u}^{2} ) du .$$

When the maximum gain combining (MGC) is employed as the joint detection scheme (corresponding to all receivers), the detection probability of the target is determined by:

$${Q}_{D} = \frac{1}{2} erfc ( \frac{{t}_{sh} - {m}_{v}}{\sqrt{{\sum }_{l , m} {V}_{m}^{( l )}}} ) , \qquad ( 13 )$$

where the overall mean value is given by

$${m}_{v} = 2 {\sum }_{l , m} \sqrt{{T}_{m}^{( l )} {T}_{m}^{( i )} {N}_{s} ( {N}_{s} + 1 )} , \qquad ( 14 )$$

where the summation is performed over all transmitters and scattered modes. The variance in (15), originating from the m-th transmitter and l-th scattered mode, is given by:

$${V}_{m}^{( l )} = {N}_{m}^{( i )} {N}_{s}^{( l )} + ( {N}_{m}^{( i )} + 1 ) ( {N}_{s}^{( l )} + 1 ) - 2 {T}_{m}^{( l )} {T}_{m}^{( i )} {N}_{s} ( {N}_{s} + 1 ) . \qquad ( 15 )$$

### Illustrative Numerical Results

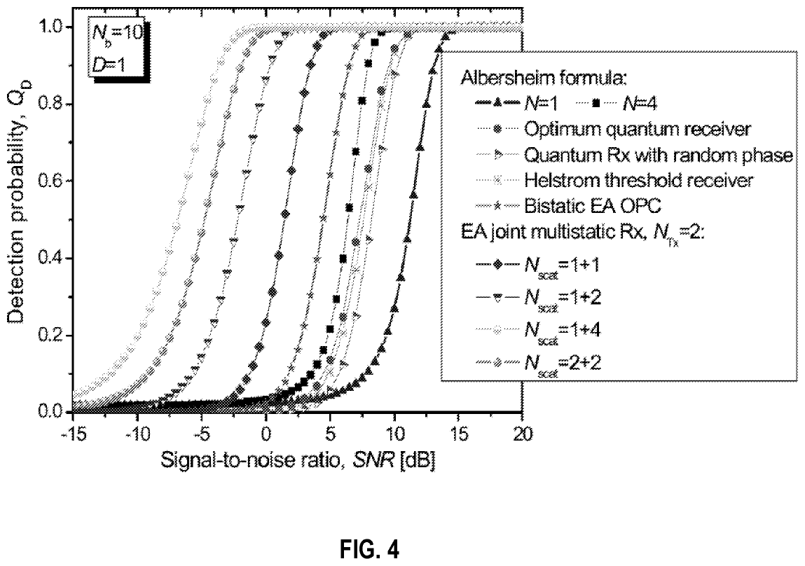

By employing two transmitters (N_{Tx}=2) and assuming that the signal and idler channels are ideal by setting the corresponding transmissivities to [symbol] =1, FIG. 4 provides a comparison of the EA joint multistatic target detection scheme implemented by the system 100 with respect to various coherent states-based schemes and EA detection schemes for bistatic radar, in terms of detection probability against SNR, for an average number of background photons N_{b}=10 and system dimensionality D=1, where the false alarm (FA) probability that can be tolerated is set to Q_{FA}=10⁻⁶. A number of forward scattered components (as well as EA receivers), denoted as N_{scat}, is varied for multistatic radar with the first component being a number of forward scattered components corresponding to the first transmitter and the second component being a number of forward scattered components corresponding to the second transmitter. For completeness of the presentation, classical Albersheim's equation-based curves are provided as well for the number of samples being set to N=1 and 4. The coherent states-based detection schemes under study include optimum quantum detector, quantum receiver (Rx) with the random phase, and Helstrom threshold receiver. Clearly, the EA joint multistatic target detection scheme employed by the system 100 significantly outperforms various coherent states-based detections schemes, the bistatic radar EA detection scheme, and the classical target detection scheme.

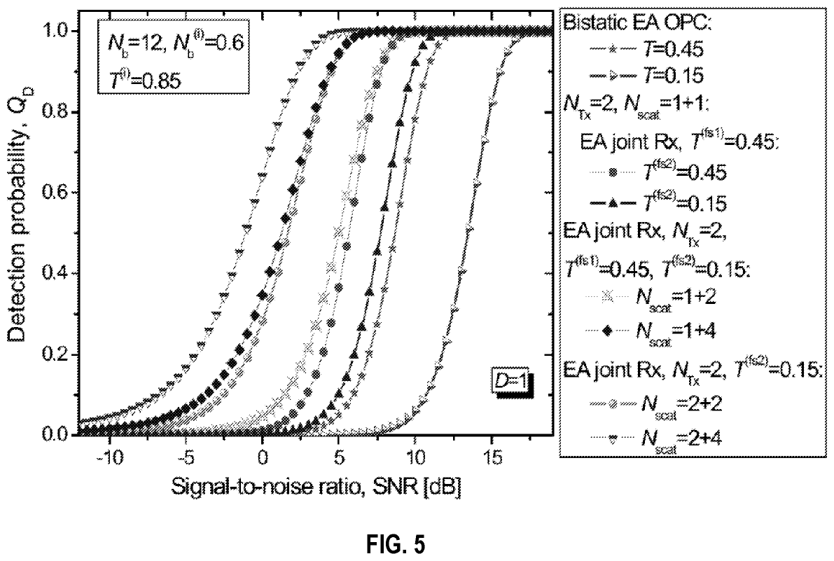

FIG. 5 studies the EA joint multistatic radar detection scheme detection probability when the transmissivities of forward scattered probe channels are different, while the average number of thermal photons is set to N_{b}=12. For simplicity, assume that all forward scattered channels corresponding to transmitter 1 are the same and equal to T^{(fs1)}=0.45. On the other hand, assume that all forward scattered channels corresponding to transmitter 2 are the same and can take one of two possible values T^{(fs2)}{0.15,0.45}. The idler channels are considered identical but less lossy and noisy [T⁽ⁱ⁾0.85 and N_{b}⁽ⁱ⁾=0.6]. The joint EA detection scheme for T ^{(fs1)}=0.45 and T^{(fs2)}=0.15 outperforms the EA detector for bistatic radar with transmissivity T=0.45 by even 6.3 dB at Q_{D}=0.95.

The system 100 implements an EA joint multistatic quantum radar detection scheme, employing integrated entangled source shared among multiple transmitters and performing the optical phase conjugation on transmitter side. EA receivers are based on classical homodyne detection schemes, simplifying receiver design. The EA joint multistatic radar scheme employed by the system 100 has been evaluated against the coherent states-based quantum detection schemes and EA bistatic radar detection scheme and it is shown that the detection probability of the EA joint multistatic target detection scheme is been significantly better than that of corresponding coherent states-based quantum detection schemes, the classical detection, and EA detection scheme for bistatic radar. When both scattered signal photon and idler channels are noisy and lossy, the EA joint multistatic radar scheme employed by the system 100 significantly outperforms the EA bistatic radar scheme.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method, comprising:
generating, using one or more integrated entanglement assisted (EA) transmitters, a plurality of entangled pairs of photons, wherein each entangled pair of photons includes a signal photon and an idler photon such that the plurality of entangled pairs of photons collectively include a plurality of signal photons and a plurality of idler photons;
performing optical phase conjugation (OPC) for each signal photon included in the plurality of entangled pairs of photons to output a respective quantum radar probe;
transmitting each respective quantum radar probe using an expanding telescope associated with each of the one or more integrated entanglement assisted (EA) transmitters;
storing each idler photon included in the plurality of entangled pairs of photons as a local reference in a quantum memory of an EA receiver of a plurality of EA receivers;
receiving, using one or more compressing telescopes, a corresponding one or more radar returns based on a reflection of each respective quantum radar probe; and
performing target detection based on entangled states processing of the one or more radar returns and each idler photon stored as the local reference.

2. The method of claim 1, wherein each respective entangled pair of photons is generated using a broadband entangled source, wherein the broadband entangled source applies a continuous-wave spontaneous parametric down conversion (SPDC) methodology.

3. The method of claim 2, wherein the plurality of integrated EA transmitters is associated with the broadband entangled source and a Wavelength Division Multiplexing (WDM) demultiplexer, wherein the broadband entangled source and the WDM demultiplexer collectively serve as a common broadband entangled source for the plurality of integrated EA transmitters.

4. The method of claim 3, further comprising:
separating the plurality of idler photons by the WDM demultiplexer with corresponding outputs being directed towards quantum memories (QMs) of corresponding EA receivers of the plurality of EA receivers.

5. The method of claim 1, wherein the radar return is detected using one or more EA receivers implementing classical coherent detection such that OPC is performed only on a transmitter side.

6. A method comprising:
generating L entangled pairs of photons, where an n^{th} pair of the L entangled pairs includes an n^{th} signal photon and an n^{th} idler photon and an (n+1)^{th} pair of the L entangled pairs includes an (n+1)^{th} signal photon and an (n+1)^{th} idler photon, where L>2 and where n, (n+1)∈[1, . . . , L];
storing the [symbol] idler photons as [symbol] local references, respectively, in a quantum memory;
transmitting, using an n^{th} integrated entanglement assisted (EA) transmitter.
an n^{th} quantum radar probe generated through application of a continuous-wave spontaneous parametric down conversion (SPDC) methodology, followed by application of an optical phase conjugation (OPC) methodology for the nth signal photon, wherein transmission is performed using an nth expanding telescope;
transmitting, using an (n+1)^{th} integrated EA transmitter:
an (n+1)^{th} quantum radar probe generated through application of the SPDC methodology, followed by application of the OPC methodology for the (n+1)^{th} signal photon, wherein transmission is performed using an (n+1)^{th} expanding telescope;
detecting, using a plurality of EA receivers, a forward scattering of the n^{th} signal photon and/or the (n+1)^{th} signal photon;
analyzing a reflection of the n^{th} signal photon and the n^{th} idler photon stored as local reference.

7. The method of claim 6, further comprising:
employing a phase modulator on transmitter side to impose a sequence, the sequence being common to each EA transmitter of a plurality of EA transmitters, where a high-speed Q-ary PSK-modulated packet is sent at each signaling interval of a plurality of signaling intervals of the sequence;
estimating a random phase shift using the sequence; and
determining a delay between the nth signal photon and the nth idler photon through application of a crosscorrelation method.

8. The method of claim 6, further comprising:
directing, by an expanding telescope of the n^{th} integrated EA transmitter, the n^{th} signal photon towards a target through a noisy and lossy Bosonic channel exhibiting atmospheric turbulence; and
detecting, at an EA radar receiver of the plurality of EA receivers, a forward-scattered photon, where the EA radar receiver employs a spatial MIMO concept to improve tolerance to turbulence effects;
wherein each integrated EA transmitter of a plurality of integrated EA transmitters are separated such that associated channels are statistically independent from one another; and
wherein each integrated EA transmitter of the plurality of integrated EA transmitters includes a plurality of expanding telescopes or a plurality of apertures of a single expanding telescope associated with the integrated EA transmitter.

9. The method of claim 8, further comprising:
combining outputs of the plurality of EA receivers at a joint receiver, the joint receiver implementing an equal gain combination or a maximum gain combination.

10. The method of claim 8, wherein multiple transmit apertures within the same expanding telescope are used to illuminate different portions of the target and ensure statistical independence of different reflections or scattered modes such that the spatial diversity can be utilized.

11. The method of claim 7, wherein the EA receiver determines an overall phase as follows:
$${φ}_{m}^{( l )} = {tan}^{- 1} [ \frac{〈 {\hat{ι}}_{BD , m}^{( l )} ( Δ φ = - π / 2 ) 〉}{〈 {\hat{ι}}_{BD , m}^{( l )} ( Δ φ = 0 ) 〉} ]$$
wherein θ_{mod} is known by the plurality of EA receivers and wherein the EA receiver determines a deterministic phase as follows:
$${ϑ}_{m}^{( l )} = k ( {r}_{m} + {R}_{m}^{( l )} ) .$$

12. The method of claim 11, further comprising:
applying, at the EA receiver, a classical heterodyne balanced detector followed by a correlator to determine a delay between the n^{th} signal photon and the nth idler photon, where the delay is related to a target range; and
adjusting a variable optical delay line that stores the n^{th} idler photon.
